(19) United States
(12) Patent Application Publication
(10) Pub. No.: US 2026/0064870 A1
(43) Pub. Date: Mar. 5, 2026

(54) METHOD AND SYSTEM FOR SELECTIVELY RESPONDING TO USER REQUESTS FOR DOCUMENTS BASED ON USER PROFILES

(71) Applicant: Schlumberger Technology Corporation, Sugar Land, TX (US)

(72) Inventors: Arvind Sharma, Houston, TX (US); Jing Wu, Houston, TX (US); Babu Sai Sampath Reddy Vinta, Houston, TX (US)

(21) Appl. No.: 18/822,787

(22) Filed: Sep. 3, 2024

(51) Int. Cl. G06F 21/62; G06F 16/33

(52) U.S. Cl. CPC G06F 21/6218; G06F 16/3344; G06F 2221/2113; G06F 2221/2141

(57) ABSTRACT

Certain aspects of the disclosure provide a method that selectively extracts information from a knowledge base of an organization based on roles of users in the organization. A first large language model (LLM) is used to identify one or more blocks of text that a user is permitted to access based on a prompt input by the user via a user interface (UI) and the role of the user in the organization. A second LLM is used to generate a response to the prompt based on text of the prompt and the one or more blocks of text that the user is permitted to access. The response is displayed is UI. The response contains the one or more blocks of text that the user is permitted to access in the knowledge base.

### BACKGROUND

### Field

Aspects of the present disclosure relate to using artificial intelligence in selectively extracting information from a knowledge base of an organization based on roles of users in the organization.

### Description of Related Art

Search tools are software applications that are designed to find and retrieve information in a knowledge base in response to key words or phrases input by users. A user interacts with a search tool via a user interface, such as by typing a request into the user interface or by using voice dictation technology. The search tools try to understand the intent of the user and generate a response with the information retrieved from the knowledge base.

Although search tools have been created in recent years with the ability to better understand and interpret the intent of a user submitting a request, these search tools lack the ability to determine what information is appropriate to output in response to a user's request. For example, when a user submits a search for particular information, the search tool initiates a search for all relevant information the tool has access to in order to satisfy the user's request. The tool retrieves documents with the relevant information and displays the documents in full to the user via a user interface.

However, in addition to the relevant information the user requested, the documents may contain content that the user is not permitted to view. In other words, the tool has responded to a user's request regardless of whether the user is permitted to view all content of the information retrieved in the search. Such responses pose the risk of leaking sensitive information to users regardless of whether the user has permission to access the information.

### SUMMARY

One aspect provides a method for selectively extracting information from a knowledge base of an organization based on the role of a user in the organization. In particular, the method receives a prompt input by a user via a user interface (UI) and a role of the user in the organization. The prompt contains a request for information from a knowledge base of an organization. The prompt is input to a first large language model (LLM) to identify a block of text that is contained in a document stored in the knowledge base, semantically similar to the request for information, and accessible to the user based on the role of the user. The block is input to a second LLM to generate a response to the request for information. The response is displayed in the UI. The response contains the block of text that satisfies the request for information in the prompt and contains only the information the user is permitted to access in the knowledge base based on the role of the user in the organization.

Another aspect provides a method for selectively extracting information from a knowledge base of an organization based on the role of a user in the organization. In particular, the method displays a user interface (UI) on a display device of a computer system that enables a user to input a prompt that contains a request for information in a knowledge base of an organization and input a role of the user in the organization. In response to receiving the prompt as input, the method accesses a data store of definitions of roles in an organization, forms safety prompts from a safety prompt template, each safety prompt having a different combination of a block of text extracted from documents of the knowledge base and a definition of a role in the organization, inputs each safety prompt into a first LLM to generate a corresponding relevance score, and inputs the prompt and blocks of text with relevance scores that are greater than a relevance score threshold into a second LLM to generate a response to the prompt. The method displays the response in the UI on the display device. The response contains the one or more blocks of text that satisfy the request for information in the prompt and the user is permitted to access based on the user's role in the organization

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts a high-level view of example method for enabling a user to extract information from a knowledge base based on a request from the user with a role that limits the user's access to sensitive information stored in the knowledge base.

FIG. 2 depicts an example of dividing the content of a document in the knowledge base into blocks of text.

FIG. 3 depicts an example user interface that enables a user to input a prompt.

FIG. 4 depicts an example of identifying semantically similar blocks of text to the text of the prompt.

FIG. 5 depicts an example of vector representations of blocks of text and a prompt vector representation of a prompt.

FIG. 6 depicts an example of forming safety prompts for different combinations of various roles of people in an organization and blocks of text.

FIG. 7 depicts an example of different example safety prompts input separately to a large language model (LLM) that generates corresponding relevance scores.

FIG. 8 depicts an example of a modified prompt input to an LLM to generate a response.

FIG. 9 depicts a flow diagram of a method for extracting information from a knowledge base based on a prompt from the user and the user's role that limits the user's access to sensitive information stored in the knowledge base.

FIG. 10 depicts a flow diagram of a process to determine blocks of text that are contextually related to the role of the user described in FIG. 9.

FIG. 11 depicts an example processing system with which aspects of the present disclosure can be performed.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Traditional search tools used by people in an organization to extract information stored in a knowledge base of the organization do not distinguish between the various roles of the people within the organization. In this context, a role is generally a function, position, or occupation of a person in the organization. For example, many documents produced within an organization may contain different types of information that are relevant to people with different roles in the organization and may contain other types of information that are not intended for everyone in the organization to view. Documents may have been modified or amended by people with different roles in the organization. Certain information added to these documents may not be intended to be accessed by everyone in the organization because the information may, for example, relate to management decisions that management is not prepared to announce, may contain confidential financial information, or may contain legal opinions about topics that are confidential or privileged.

With traditional search tools, the roles of people in an organization conducting a search are not factored into the type of information the search tool extracts from a knowledge base. For example, a user can submit a search for information regarding a particular topic that relates to the user's role with the organization. The traditional search tool typically identifies all the documents in the knowledge base that contain the information the user requested and provides the user with access to the documents in full, regardless of whether the documents contain sensitive information that the user should not have been able to access.

As a result, the user is presented with search results that contain information the user should not have been permitted to access or view based on the user's role in the organization. Alternatively, entire documents that contain certain types of sensitive information may be blocked from searches based on the roles of users in the organization even though these documents contain other types of information that users would otherwise be permitted to view. Traditional search tools do not selectively extract particular pieces of information or content from documents in a knowledge base based on the user's role in the organization.

Certain aspects of methods, systems and apparatuses described herein provide a technical solution to the above described technical problems with traditional search tools by employing artificial intelligence (AI) large language models (LLMs) to protect information in a knowledge base of an organization and only permit a user to access or view information based on the user's role within the organization. The user is provided with a user interface (UI) that enables the user to take a casual, conversational approach (i.e., chat) to inputting a request for information. The information the user has requested can be recorded in various documents that are stored in the knowledge base. These same documents may also contain sensitive information that the user is not permitted to view based on the user's role within the organization.

Methods, systems and apparatuses described herein use the LLMs to perform information extraction from any type of document stored in the knowledge base without the need to fine-tune the LLMs. Methods, systems and apparatuses described herein perform a semantic search to identify the relevant contents, or blocks of text, within the documents. The LLMs are used to filter blocks of text that contain content the user is not permitted to access or view based on the role of the user within the organization. The resulting content that the user is permitted to access or view is used by the LLMs to produce a human-readable response to the user's original request. The response contains only the content or information that the user is permitted to access or view based on the user's role in the organization and excludes the content or information that the user is not permitted to access or view.

The LLMs are used to obtain responses that are grounded only in the documents of the knowledge base, which avoids AI hallucinations. AI hallucinations occur when an LLM perceives patterns or objects that are nonexistent, which creates nonsensical, inaccurate, or false outputs.

### Example Implementation of an Artificial Intelligence-Based Method for Selectively Responding with Content of Documents Based on User Roles

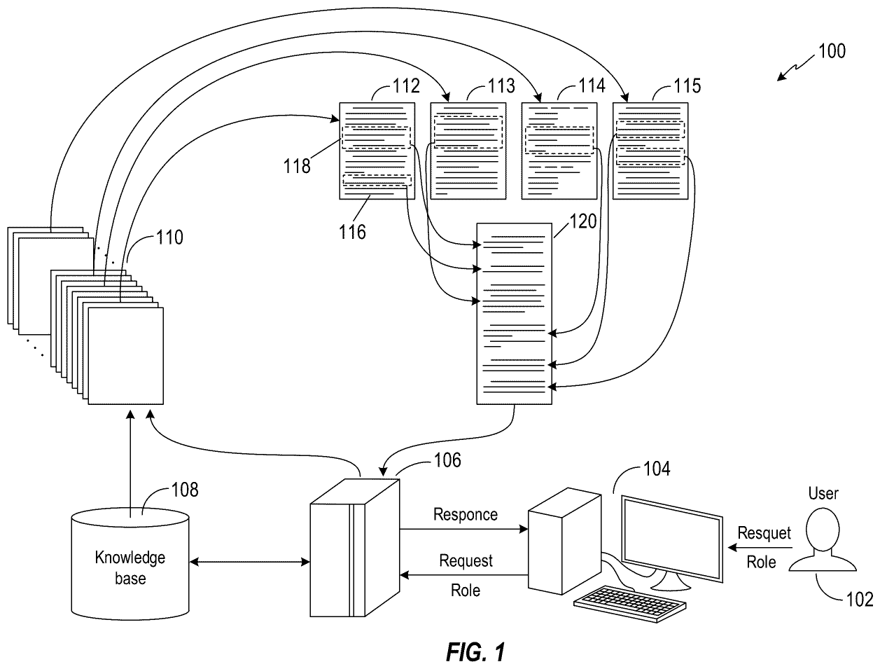

FIG. 1 depicts a high-level view 100 of example method for enabling a user to extract information from a knowledge base of an organization based on a request from the user and further based on the user's role in the organization that limits the user's access to sensitive information stored in the knowledge base. In the example of FIG. 1, a user 102 submits a request for information and inputs the role of the user 102 in the organization via a user interface (UI) running on a computer system 104. The UI may be provided by a web browser or an application running on the computer system 104, a tablet (not shown), or a smart mobile device (not shown). The request and user's role are forwarded to a computer server 106. The computer server 106 may be located on premises of the organization or in the cloud. Knowledge base 108 stores documents 110 of the organization. The documents 110 can be reports, letters, contracts, memos, proposals, emails, technical descriptions, lab reports, survey results, manuals, notes, and other types of written material produced by people having different roles within the organization.

The computer server 106 performs the process of filtering the content of the documents by identifying blocks of text (i.e., blocks) the user 102 is permitted to access or view based on the user's role in the organization and generates a response that contains only those blocks of text in accordance with aspects described below. For example, as shown in FIG. 1, four documents 112-115 contain information that satisfies the request submitted by the user. Horizontal lines, such as horizontal line 116, represent lines of text composed of character strings, such as words, tokens, and parameters. Blocks of text that the user 102 is permitted to access or can view are enclosed by dashed-line rectangles. For example, dashed-line rectangle 118 encloses a block of text in the document 112 that satisfies the user's request and contains content that the user 102 is permitted to access.

The computer server 106 forms a response 120 that is composed of the blocks of text that satisfy the user's request and contain content that the user 102 is permitted to access or view in accordance with aspects described below. Note that the text outside the blocks of text in the documents 112-115 is not included in the response 120 because this text may be irrelevant with respect to the request submitted by the user 102 or may contain sensitive information that the user 102 is not permitted to access based on the user's role in the organization. The response 120 is sent from the computer server 106 to the computer system 104. The response 120 can be viewed by the user 102 in the UI running on the computer system.

### Vector Embedding

Methods and system described herein are directed to identifying and retrieving only the relevant contents, or blocks of text, within the documents stored in the knowledge based 108. Methods and systems begin with dividing (or chunking) the content of each document stored in the knowledge base 108 into blocks (or chunks) of text. The blocks of text are then embedded in vectors of an N-dimensional space and stored in a vector data store. As new documents are added to the knowledge base 108, the contents of the documents are divided into blocks of text, embedded in vectors of the N-dimensional space, and stored in the vector data store.

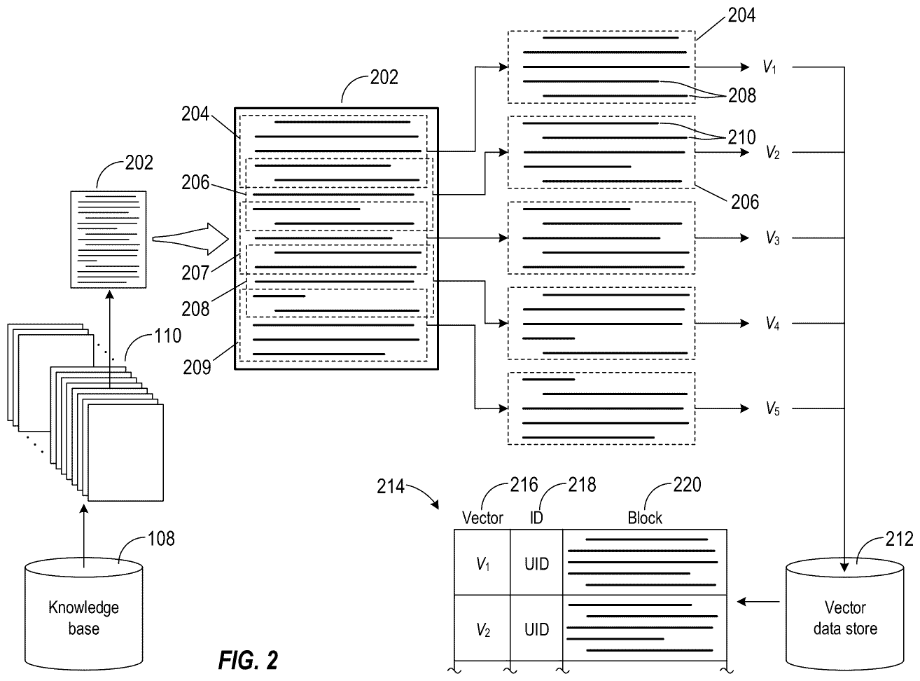

FIG. 2 depicts an example of dividing the content of a document 202 in the knowledge base 108 into blocks of text. Dashed-line rectangles 204-209 enclose overlapping blocks of text that are displayed separately. For example, lines of text 208 of the block of text 204 are the same lines of text 210 of the block of text 206. Each block of text is composed of a set of characters, such as ASCI characters, of the document, lines of text, and the number of characters in a block of text cannot exceed a character limit. For example, in certain implementations, the number of characters per block is limited to at most 500. In another implementation, the number of characters per block is limited to at most 1000. In still other implementations, the number of characters per block is limited to at most 2000. These are just some examples, and other limits are possible. Alternatively, blocks may be limited by the number of tokens. For example, in another implementation, the number of tokens per block is limited to at most 20. In another implementation, the number of tokens per block is limited to at most 30.

Each block of text is embedded in a vector of the N-dimensional space using vector embedding, such as Chroma®, Pinecone, or Facebook AI Similarity Search (Faiss). Each vector is denoted by Vᵢ=[x₁ᵢ, . . . , x_{Ni}], where i is a positive integer vector index and xₙᵢ is a real number. For example, in FIG. 2, the block of text 204 is embedded in the vector V₁ and the block of text 206 is embedded in the vector V₂. The vectors are stored along with the corresponding blocks of text in a vector data store 212. Table 214 represents the vectors and corresponding blocks of text stored in the vector data store 212. Column 216 contains the vector representations of the blocks of text. Column 218 contains the unique identifier of the document the vector was extracted from. Column 220 contains the block of text that corresponds to the vector.

### User Interface

The user 102 can submit a prompt that contains the user's request for information recorded in the knowledge base 108 and input the role of the user 102 within an organization via a UI. The prompt is embedded in the same N-dimensional space as the vectors of the blocks of text.

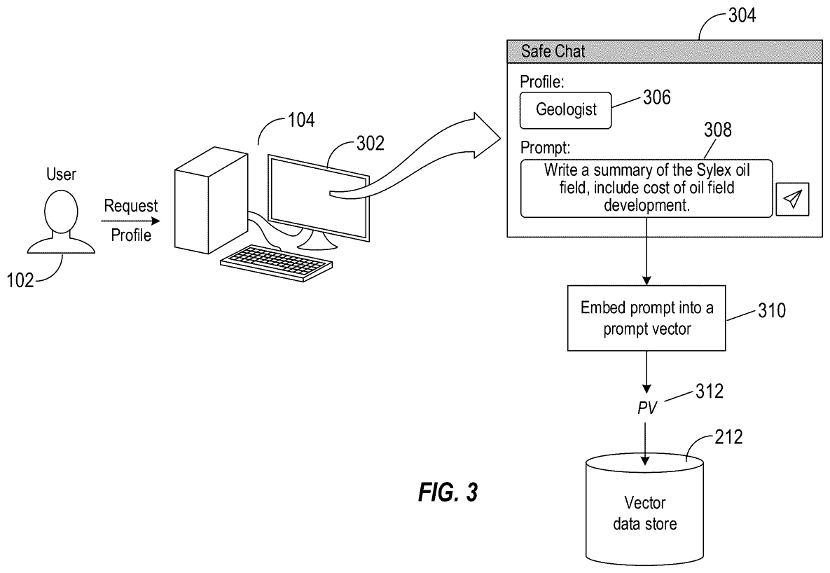

FIG. 3 depicts an example UI 304 displayed on the monitor 302 of the computer system 104. In this example, the UI 304 includes a profile field 306 that displays the role of the user 102 within the organization. The user's role may be obtained from a personnel profile, which is managed by the administration. For example, when the user 102 logs in the user's role may be checked against the user's employee information stored in the personnel data base of the organization. In this example, the user's role of “geologist” is displayed in the field 306. This example UI 304 includes a prompt field 308 that enables the user 102 to submit a prompt in the form of request for information. A prompt is a mode of interaction between the user 102 and the LLMs described below to generate the response to the user's request. The prompt submitted by the user 102 can be any form of text, question, information, or coding that communicates to the LLMs the type of information the user 102 is requesting from the knowledge base 108. Block 310 represents the process of embedding the prompt entered into the field 308 into a prompt vector 312 in the same N-dimensional space using the same embedding technique used to create the vector representations of the blocks of text described above with reference to FIG. 2. The prompt vector 312 is denoted by PV=[y₁, . . . , y_{N}], where yₙ is a real number and n=1, . . . , N.

In the example of FIG. 3, the prompt is submitted as a casual, conversational command to generate a response that contains a summary of information about an oil field and includes a request for the cost of developing the oil field. However, the role of the user 102 in the organization is a geologist. Methods described herein access the information regarding the oil field in various documents of the knowledge base 108. Certain documents that contain geological information about the oil field may have been created and amended by people with different roles in the organization. For example, the documents may contain accounting information regarding the cost of developing the oil field, information regarding the cost of test drilling, and may contain the opinions of petroleum engineers and managers that are intended to remain confidential. These different types of information recorded in the documents may be regarded as sensitive and are only permitted to be viewed by people with particular roles in the organization.

Note that the role of the use 102 and information requested is not limited to geologist and oil field information. The organization is not limited to the oil and gas industry. The organization can be any type of organization. For example, the organization can be any type of body of people organized for a particular purpose, such as company, a firm, a corporation, association, or a governing body. The role of the user can be any position in an organization including, but not limited to, an engineer, a project engineer, a project manager, a well site manager, a field specialist, a scientist, a software developer, an IT specialist, an accountant, a data analyst, a data scientist, a human resources manager, an executive officer, a financial officer, and legal counsel. The information may be any type of information generated by employees, contractors, or people outside of the organization.

### Identifying Blocks of Text that are Semantically Similar to the Text of the Prompt

Cosine similarity can be used as a quantitative measure of the semantic similarity between the text of the prompt and the blocks of text based on the vector representations of the blocks of text and the prompt vector in the N-dimensional space. The terms “semantically similar” and “semantic similarity” refer to how close in meaning the text of the prompt is to the meaning of a block of text. The semantic similarity is quantitatively measured by computing the cosine of the angle between a vector representation of a block of text and the prompt vector regardless of the lengths of the corresponding vectors. A block of text and the text of the prompt are regarded as semantically similar (i.e., similar meaning) if the two corresponding vectors are pointing in roughly the same direction. By contrast, a block of text and the text of the prompt are regarded as not semantically similar if the two corresponding vectors point in largely different or opposing directions. The blocks of text that are semantically similar to the text of the prompt are further processed using LLMs as described below to formulate a response composed of blocks of text that the user is permitted to access or view based on the user's role in the organization as described below in the subsection Large Language Models.

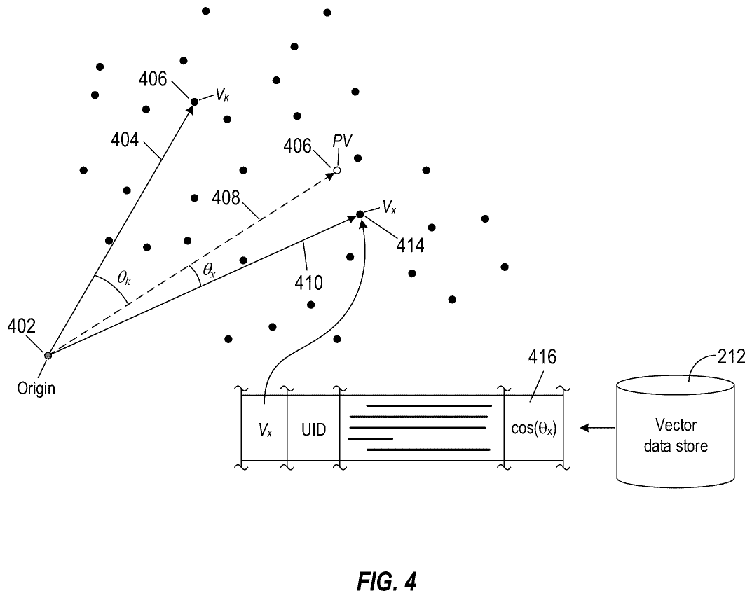

FIG. 4 depicts an example of identifying semantically similar blocks of text to the text of the prompt. The N-dimensional vector representations of the blocks of text are represented by directional arrows emanating from an origin 402. For simplicity of illustration, the N-dimensional space is illustrated in 2-dimensions and only the end points of the vectors are represented by solid points. For example, vector, Vₖ, 404 represents a first block of text that ends at a point 406, and vector, Vₓ, 408 represents a second block of text that ends at a point 410. Dashed directional arrow represents the prompt vector, PV, 412 that ends at an open point 414. The cosine similarity is calculated for each vector representation of the blocks of text and the prompt vector as follows:

$$cos ( {θ}_{i} ) = \frac{{V}_{i} \cdot PV}{‖ {V}_{i} ‖ ‖ PV ‖} \qquad ( 1 )$$

where
θᵢ denotes the angle between the vector Vᵢ of a block of text and the prompt vector PV;
“⋅” denotes the scalar or dot product; and
∥⋅∥ denotes the norm of a vector.

The cosine similarity ranges between −1 and 1 and measures the degree of semantic similarity between the blocks of text and the prompt. The closer the cosine similarity of the vectors Vᵢ and PV is to “1” (i.e., θᵢ is to zero), the more semantical similar the corresponding text. The further the cosine similarity of the vectors Vᵢ and PV is away from “1” (i.e., θᵢ>0), the more dissimilar the corresponding text.

For example, in FIG. 4, the angle θₓ is the angle between the vector representation, Vₓ, of a block of text and the prompt vector PV, and the angle θₖ is the angle between the vector representation, Vₖ, of a block of text and the prompt vector PV. The cosine similarity between the vector Vₓ 410 and the prompt vector PV 408 is closer to 1 than the cosine similarity between the vector Vₖ 404 and the prompt vector PV 408 (i.e., θₓ<θ_{y}). The cosine similarity associated with each vector representation of a block of text is recorded in the vector data store 212. For example, the table entry for the vector Vₓ includes an entry for the cosine similarity 416.

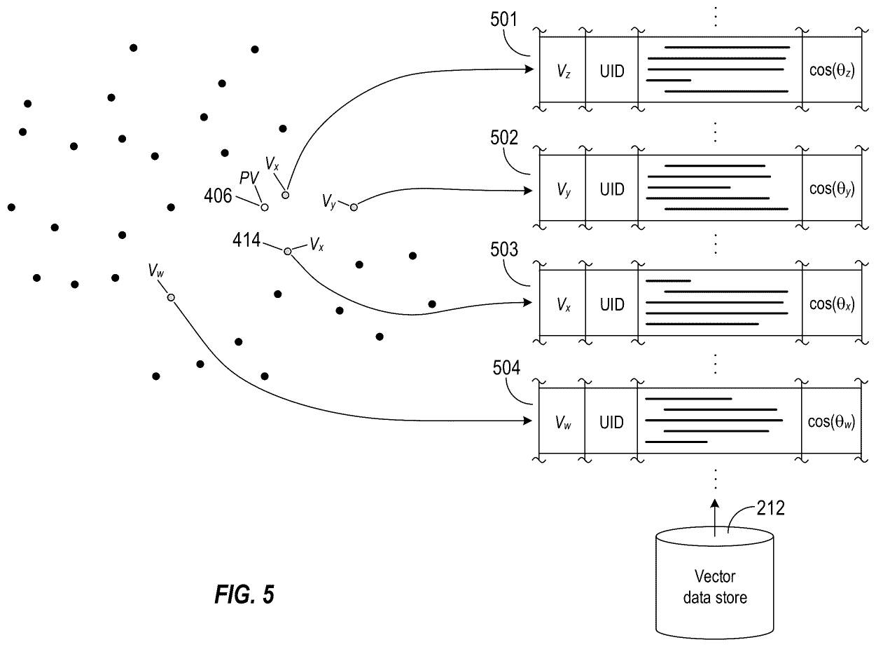

FIG. 5 depicts an example of four vectors with corresponding cosine similarities closest to the prompt vector. The four vectors that represent four blocks of text that are the most semantically similar to the text of the prompt are denoted by V_{w}, Vₓ, V_{y}, and V_{z}. In FIG. 5, the vectors are represented by entries 501-504 in the table stored in the vector data store 212.

In one implementation, the blocks of text with vector representations having the K (e.g., K=3, 5, or 10) largest corresponding cosine similarities to the prompt vector can be identified as the K blocks of text that are candidates for forming a response to the prompt. The K blocks of text with the largest corresponding cosine similarities have the highest semantic similarity to the prompt.

In another implementations, the blocks of text may be identified using a similarity threshold, Thₛᵢₘ. The similarity threshold can be used to identify the closest blocks of text to the prompt by only identifying blocks of text with corresponding cosine similarities that are greater than the similarity threshold. For example, Thₛᵢₘ can be set to 0.5, 0.7, or 0.9 for identifying the blocks of texts that are the most semantically similar to the prompt. The blocks of text with the corresponding cosine similarities greater than the similarity threshold have the highest semantic similarity to the prompt.

In another implementation, the technique of K-nearest neighbors can be used as a quantitative measure of the semantic similarity between the text of the query and the blocks of text based on the vector representations of the blocks of text and the query vector in the N-dimensional space. The K closest vector representations of the blocks of text to the query vector in the N-dimensional space are identified as semantically similar to the query vector. The K-nearest neighbor technique determines an optimum positive integer value for K-nearest neighbor vector representations of the blocks of text to the query vector. For example, an approximate query vector is calculated as an average of the K nearest vectors to the query vector for different values of K (e.g., K=1, 2, 3, 4, 5, 6, . . . ). The value of K with the smallest mean square error between the approximate query vectors and the query vector is the optimum K. The blocks of text with corresponding vectors for the optimum K are semantically similar to the query.

### Large Language Models

Certain methods, systems, and apparatuses described below use LLMs to extract from the documents only the information that the user is permitted to access or view and to form a response from the information and output the response in a human-readable report. The resulting response contains only the information of the documents that the user 102 is permitted to access and excludes sensitive information that the user 102 is not permitted to access. For example, although the user 102 in FIG. 3 has requested to view the cost of developing the oil field in the prompt, the user 102 may not be permitted to view the cost to develop the oil field based on the role of the user 102.

Many of the blocks of text with the highest semantic similarity to the prompt may contain text that the user 102 is not permitted to view. A first large language model (LLM_1) is used to determine which of the blocks of text with the highest semantic similarity contain text that the user is not permitted to access or view. The LLM_1 can be a generative pre-trained transformer (GPT), such as GPT 3.5 or GPT 4, or Gemini AI. In other words, the LLM_1 is used to determine a safe embedding that is composed of the blocks of text the user 102 is not permitted to access based on the role of the user. The term “safe embedding” refers to blocks of text that are kept safe or protected from being accessed or viewed by the user 102 based on the user's role in the organization. The LLM_1 has a deep learning transformer architecture and have been pre-trained to generate a relevance score that is a measure of how contextually related the roles of people in the organization are to different textual descriptions. Combinations of safety prompts are formed from the highest ranked blocks of text and definitions of the various roles of people in the organization. Each safety prompt is formed from a safety prompt template denoted by “safety_prompt (Block, Definition),” where the variable “Block” denotes a block of text and the variable “Definition” denotes the definition of a role in the organization.

If there are R different roles in the organization and K blocks of text with the highest semantic similarity to the prompt, then R×K different safety prompts are created. Each of the R×K safety prompts is separately input to the LLM_1 to generate a corresponding relevance score denoted by RC. The relevance score is a measure of how closely connected or related the text of the role is to the block of text. The relevance score can range between 0 and 1. A relevance score close to 0 means there is almost no contextual relationship between the role and the block of text. On the other hand, a relevance score close 1 means there is a strong contextual relationship between the definition of the role and the block of text. A relevance score threshold Th_{RC} (e.g., Th_{RC}=0.6, 0.7, or 0.8) can be used to identify blocks of text that have a high semantic similarity to the prompt, but contain text that can only be viewed by people with roles that are different from the role from the user 102. These blocks of text form the safe embedding and are excluded from the response to the prompt input by the user 102.

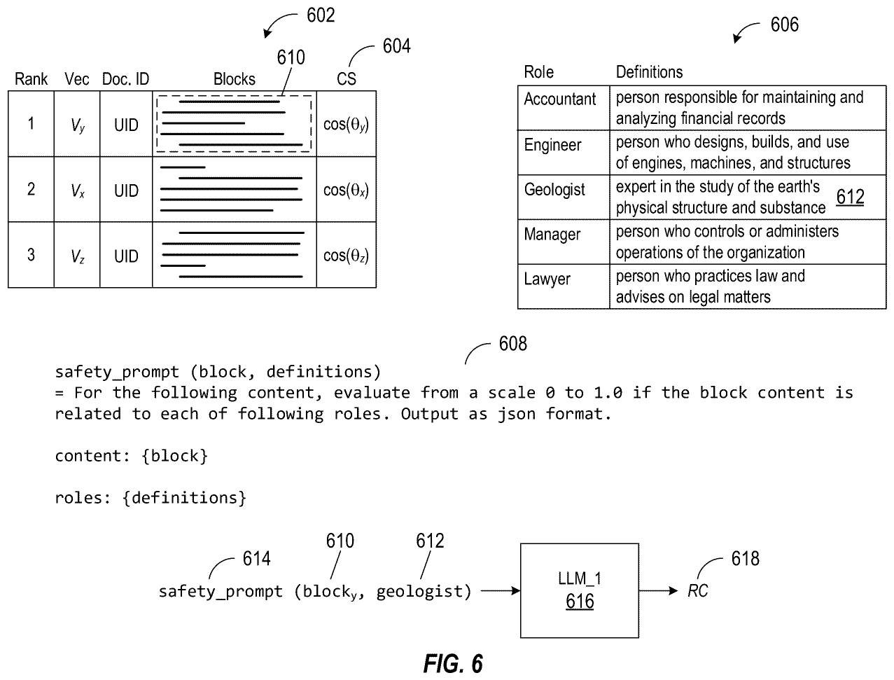

FIG. 6 depicts an example of forming safety prompts for different combinations of the various roles of people of the organization and the blocks of text with the highest semantic similarity to the prompt. Table 602 displays vectors and blocks of text for the three highest ranked (i.e., K=3) blocks of text based on corresponding cosine similarities to the prompt listed in column 604. In this example, the blocks of text are rank order based on cos(θ_{z})<cos(θₓ)<cos(θ_{y})<1. FIG. 6 displays an example table 606 of roles of people in the organization and corresponding definitions of the roles. The contents of table 606 can be stored in the knowledge base 108. For the sake of simplicity, the number of roles is limited five. In practice, the number of roles may range into the hundreds or thousands depending on the size and diversity of roles of users in the organization.

FIG. 6 shows an example safety prompt template 608 that contains an argument for inputting a block of text and an argument for inputting a definition. For example, a safety prompt created for the block of text 610 and the definition of a geologist contains the block of text 610 for the argument “Block” and the text of the definition 612 for the argument “Definition.” The safety prompt 614 formed from the block of text 610, denoted by block_{y}, and the text of the definition 612 of a geologist is input to the LLM_1 616, which, in turn, generates a corresponding relevance score RC 618. If RC>Th_{RC}, the block of text 610 is identified as having a contextual relationship to the role that corresponds to the definition 612. In this example, the number of roles is 5 (i.e., R=5) and the number of blocks of text is 3 (i.e., K=3). Fifteen safety prompts (i.e., 5×3) are created. Each safety prompt contains a different combination of blocks of text and definition of the roles.

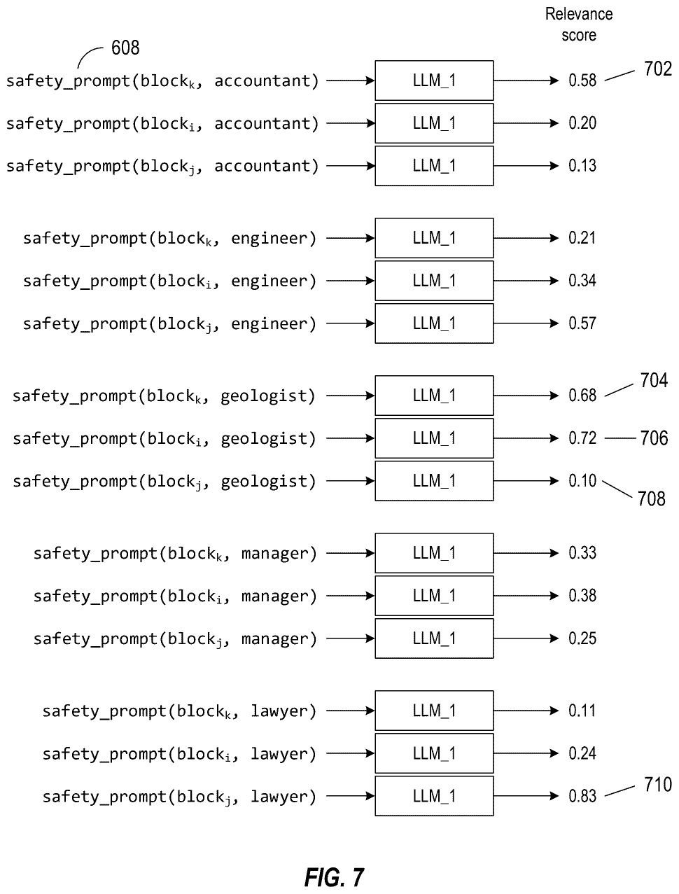

FIG. 7 depicts an example of inputting each of fifteen different safety prompts into the first LLM_1 to generate corresponding relevance scores. The safety prompts represent the fifteen different combinations of three blocks and five role definitions. The arguments of the safety prompts include one of three blocks of text denoted by chunkₖ, chunkᵢ, and chunkⱼ that correspond to the vectors Vₖ, Vᵢ, and Vⱼ in the table 602 and one of the five definitions. Suppose, for example, the relevance score threshold Th_{Rc} is set equal to 0.6. The relevance scores 702, 704, 706, 708, and 710 indicate a contextual relationship between the three blocks and three of the five roles.

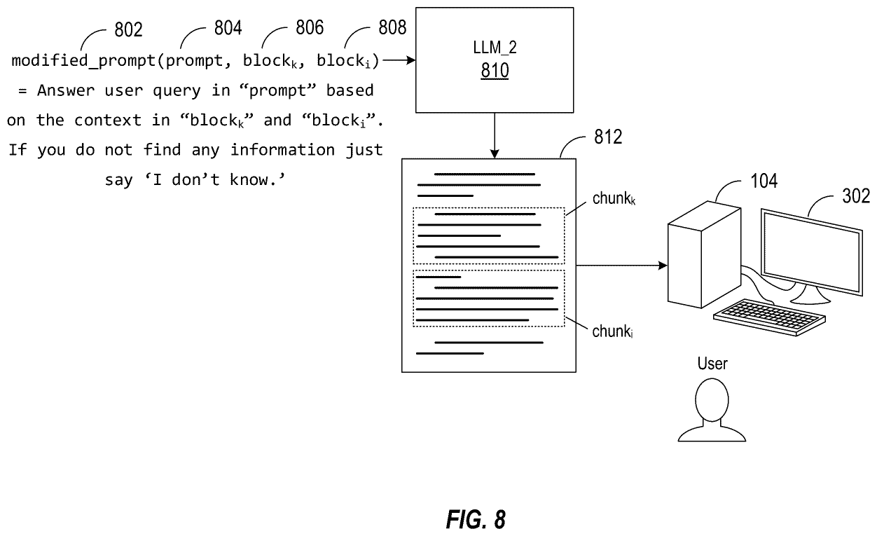

The example relevance score 706 indicates a strong contextual relationship between the block of text blockᵢ and the definition of a geologist and none of the other relevance scores determined for the block of text blockᵢ and the other definitions are greater than the relevance score threshold. As a result, the block of text blockᵢ does not belong to the safe embedding and can be used to form a response to the prompt input by the user 102 as described below with reference to FIG. 8.

The example relevance scores 708 and 710 indicate a weak contextual relationship between the block of text blockⱼ and the definition of a geologist and a strong contextual relationship between the block of text blockⱼ and the definition of a lawyer, respectively. As a result, although the block of text blockⱼ is semantically similar to the text of prompt, the block of text blockⱼ belongs to the safe embedding and is omitted from forming a response to the prompt of the user 102.

The example relevance scores 702 and 704 indicate a moderate contextual relationship between the block of text blockₖ and the definition of an accountant and a strong contextual relationship between the block of text blockₖ and the definition of a geologist, respectively. Although, the relevance score 702 is close to the relevance score threshold, the block of text blockₖ is excluded from the safe embedding and is used to form a response to the prompt input by the user 102 as described below with reference to FIG. 8. Had the relevance scores 702 and 704 both been greater than the relevance score threshold, the block of text blockₖ would belong to the safe embedding and would have been omitted from forming the response to the prompt input by the user 102.

The blocks of text that are semantically similar and are contextually related to the role of the user are referred to as a “modified embedding.” For example, the blocks of text blockᵢ and blockₖ described above with reference to FIG. 7 form a modified embedding. A modified prompt is created by combining the prompt input by the user 102 with the modified embedding. The modified prompt can be a prompt template. In other words, the modified prompt is composed of the prompt of the user 102 and the blocks of text that are semantically similar to the prompt input by the user 102, are contextually related to the role of the user, and are not contextually related to other roles of the organization are input. The modified prompt is input to a second LLM (LLM_2) that has been trained to generate a response to the prompt input by the user 102. The LLM_2 can be a generative AI model, such as GPT 3 or GPT 4, that has been trained to generate a response to a prompt input by the user. The resulting response incorporates the modified embedding, which is composed of the blocks of text that are semantically similar to the prompt input by the user 102, are contextually related to the role of the user, and not contextually related to other roles of the organization are input.

FIG. 8 depicts an example of a modified prompt 802 created from the prompt 804 input by the user 102 and a modified embedding composed of the blocks of text blockₖ 806 and blockᵢ 808 described above with reference to FIG. 7. The LLM_2 810 receives as input the modified prompt 802 and outputs a response 812. The response 812 is composed of human-readable text that incorporates the blocks of text blockₖ and blockᵢ and satisfies a request or answers a query in the prompt input by the user. The response is sent to the computer system 104 and displayed in the UI on the monitor 302, thereby enabling the user 102 to access or view only the blocks of text in the knowledge base 108 that the user 102 is permitted to access or view based on the role of the user 102.

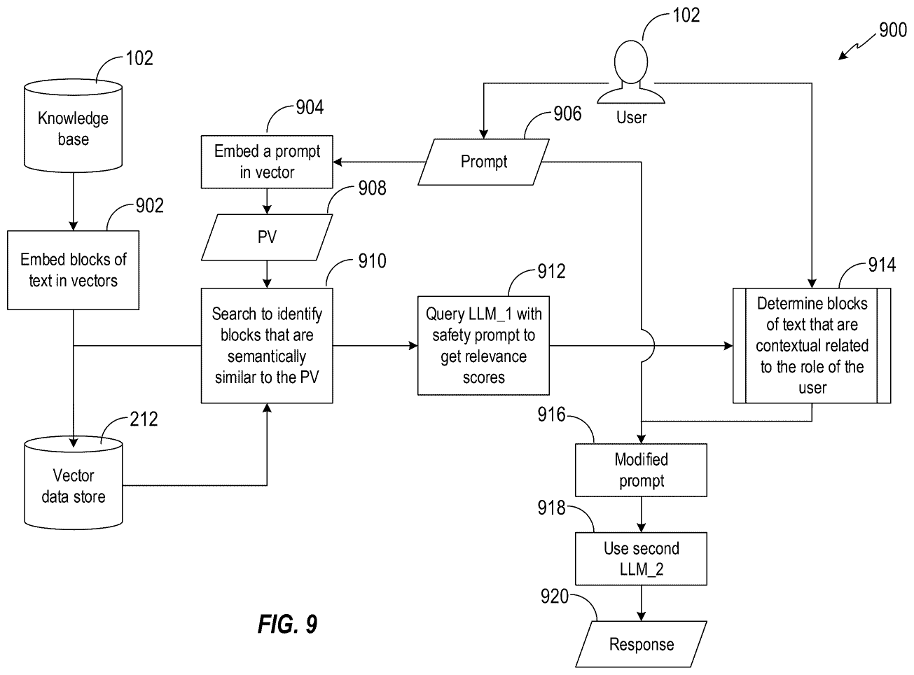

FIG. 9 depicts a flow diagram of a method 900 for extracting information from a knowledge base 108 of an organization based on a prompt from the user 102 and the user's role in the organization that limits the user's access to sensitive information stored in the knowledge base 108.

In block 902, blocks of text of the documents are embedded in vector representations of the blocks as described above with reference to FIG. 2. The vectors are stored in a vector data store 212.

In block 904, a prompt 906 input via a UI by the user 102 is embedded in a prompt vector 908 as described above with reference to FIG. 3.

In block 910, an embedding search is performed to identify blocks of text that are semantically similar to the text of the prompt 906 as described above with reference to FIGS. 4-5.

In block 912, the safety prompt described above with reference to FIG. 6 is used to query the first LLM_1 to get a relevance score for the different user roles in the organization.

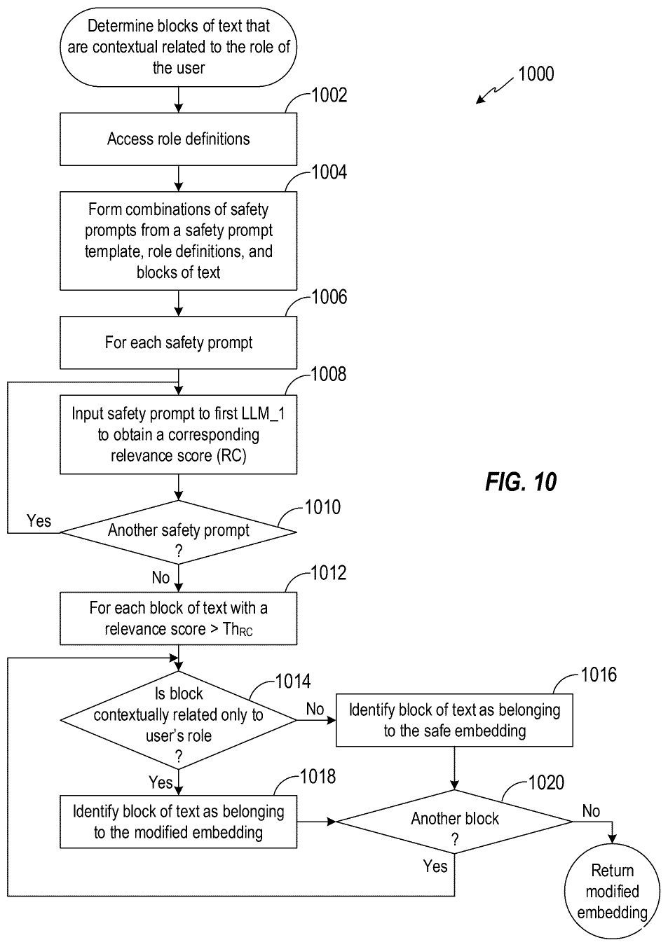

In block 914, a process to determine the blocks of text that are contextually related to the role of the user is performed. An example implementation of the process to determine the blocks of text that are contextually related to the role of the user is described below with reference to FIG. 10.

In block 916, a modified prompt is formed from the blocks of text that are contextually related to the role of the user obtained in block 914 (i.e., modified embedding) and the prompt 906 as described above with reference to FIG. 8.

In block 918, the modified prompt is input to the second LLM_2 to generate a response 920 composed of the blocks of text that are contextually related to the role of the user and excluding the blocks of text in the safe embedding as described above with reference to FIG. 8. The response 920 contains the one or more blocks of text that satisfy the prompt and the user is permitted to access or view in the knowledge base 108. The response does not include blocks of text that belong to the safe embedding.

FIG. 10 depicts a flow diagram 1000 of the process to determine the blocks of text that are contextually related to the role of the user described above with reference to block 914 in FIG. 9.

In block 1002, definitions of the roles of people in the organization are accessed as described with reference to FIG. 6.

In block 1004, combinations of safety prompts are formed from a safety prompt template, definitions of roles of people in the organization, and the highest ranked blocks of text that are semantically similar to the text of the prompt 906 as described above with reference to FIG. 6. Each safety prompt is composed of a different combination of a definition of a role and one of the highest ranked blocks of text.

A loop beginning with block 1006 repeats the operation represented by block 1008 for each safety prompt formed in block 1004.

In block 1008, a safety prompt is input to the first LLM_1 to generate a corresponding relevance score as measure of the contextual relationship between the definition of the role and the block of text.

In block 1010, the operation represented by block 1008 is repeated for another safety prompt until each of the safety prompts has been input to the first LLM_1.

A loop beginning with block 1012 repeats the operations represented by blocks 1014, 1016, and 1018 for each block of text having a corresponding relevance score that is greater than the relevance score threshold.

In block 1014, if the block of text is contextually related to a definition of a role that is different from the role of the user, control flows to block 1016. Otherwise, if the block of text is contextually related only to the definition of the role of user 102, control flows to flow to block 1018.

In block 1016, the block of text is identifies as belonging to the safe embedding described above with reference to FIG. 7. The safe embedding is composed of the blocks of text the user is not permitted to access or view.

In block 1018, the block of text is identified as belonging to the modified embedding. The modified embedding is composed of the blocks of text that user is permitted to access or view based on the role of the user in the organization as described above with reference to FIG. 7.

In block 1020, the operations represented by blocks 1014, 1016, and 1018 are repeated for another block of text having a corresponding relevance score that is greater than the relevance score threshold. The process of FIG. 10 generates the blocks of text in the documents of the knowledge base 108 that the user is permitted to access to or can view based on the user's role in the organization.

### Example Processing System for Implementing an Artificial Intelligence-based Method for Selectively Responding with Content of Documents Based on User Roles

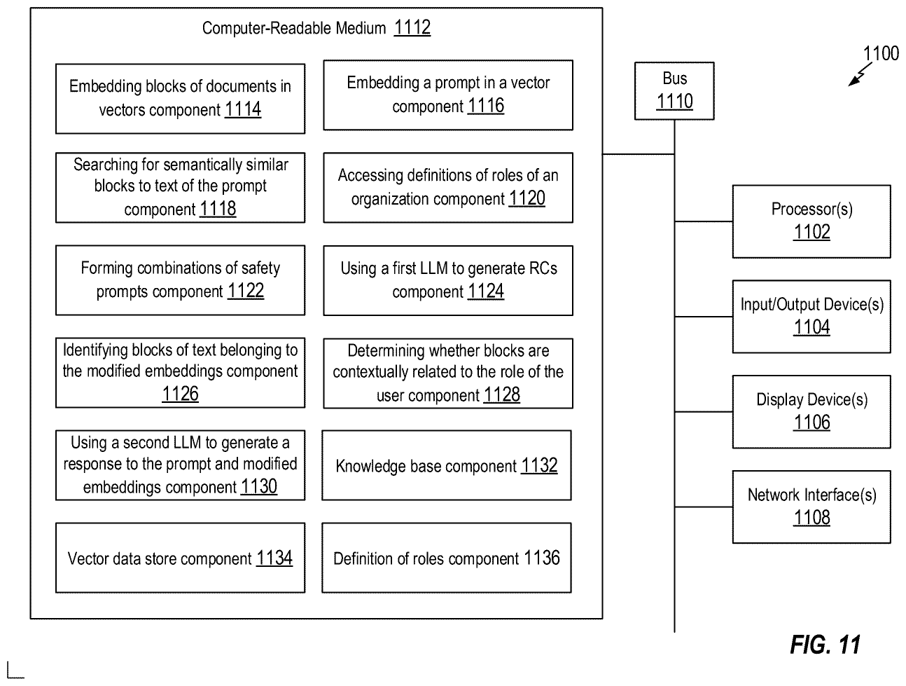

FIG. 11 depicts an example processing system 1100 configured to perform various aspects described herein, including, for example, method for extracting information from a knowledge base of an organization based on a prompt from the user and the user's role in the organization that limits the user's access to sensitive information stored in the knowledge base as described above with respect to FIGS. 9 and 10.

Processing system 1100 is generally an example of an electronic device configured to execute computer-executable instructions, such as those derived from compiled computer code, including without limitation personal computers, tablet computers, servers, smart phones, smart devices, wearable devices, augmented and/or virtual reality devices, and others.

In the depicted example, processing system 400 includes one or more processors 1102, one or more input/output devices 1104, one or more display devices 1106, one or more network interfaces 1108 through which processing system 1100 is connected to one or more networks (e.g., a local network, an intranet, the Internet, or any other group of processing systems communicatively connected to each other), and computer-readable medium 1112. In the depicted example, the aforementioned components are coupled by a bus 1110, which may generally be configured for data exchange amongst the components. Bus 1110 may be representative of multiple buses, while only one is depicted for simplicity.

Processor(s) 1102 are generally configured to retrieve and execute instructions stored in one or more memories, including local memories like computer-readable medium 1112, as well as remote memories and data stores. Similarly, processor(s) 1102 are configured to store application data residing in local memories like the computer-readable medium 1112, as well as remote memories and data stores. More generally, bus 1110 is configured to transmit programming instructions and application data among the processor(s) 1102, display device(s) 1106, network interface(s) 1108, and/or computer-readable medium 1112. In certain embodiments, processor(s) 1102 are representative of a one or more central processing units (CPUs), graphics processing unit (GPUs), tensor processing unit (TPUs), accelerators, and other processing devices.

Input/output device(s) 1104 may include any device, mechanism, system, interactive display, and/or various other hardware and software components for communicating information between processing system 1100 and a user of processing system 1100. For example, input/output device(s) 1104 may include input hardware, such as a keyboard, touch screen, button, microphone, speaker, and/or other device for receiving inputs from the user and sending outputs to the user.

Display device(s) 1106 may generally include any sort of device configured to display data, information, graphics, user interface elements, and the like to a user. For example, display device(s) 1106 may include internal and external displays such as an internal display of a tablet computer or an external display for a server computer or a projector. Display device(s) 1106 may further include displays for devices, such as augmented, virtual, and/or extended reality devices. In various embodiments, display device(s) 916 may be configured to display a graphical user interface.

Network interface(s) 1108 provide processing system 1100 with access to external networks and thereby to external processing systems. Network interface(s) 1108 can generally be any hardware and/or software capable of transmitting and/or receiving data via a wired or wireless network connection. Accordingly, network interface(s) 1108 can include a communication transceiver for sending and/or receiving any wired and/or wireless communication.

Computer-readable medium 1112 may be a volatile memory, such as a random access memory (RAM), or a nonvolatile memory, such as nonvolatile random access memory (NVRAM), or the like. In this example, computer-readable medium 1112 includes an embedding blocks of documents in vectors component 1114 as described above with reference to FIG. 2 and block 902 of FIG. 9.

The computer-readable medium 1112 includes embedding a prompt in an embedding component 1116 that embeds the prompt input by the user into vector as described above with reference to FIG. 3 and block 904 of FIG. 9.

The computer-readable medium 1112 includes a searching for semantically similar blocks of text to the text of prompt component 1118 as described above with reference to FIGS. 4-5 and block 910 of FIG. 9.

The computer-readable medium 1112 includes an accessing definition of roles of an organization component 1120 as described above with reference to FIG. 6 and block 1002 of FIG. 10.

The computer-readable medium 1112 includes a forming combinations of safety prompts component 1122 as described above with reference to FIG. 6 and block 1004 of FIG. 10.

The computer-readable medium 1112 includes a using a first LLM to generate relevance scores component 1124 as described above with reference to FIG. 6-7 and block 1008 of FIG. 10.

The computer-readable medium 1112 includes an identifying blocks belonging to the modified embeddings component 1126 as described above with reference to FIG. 8 and block 1008 of FIG. 10.

The computer-readable medium 1112 includes a determining whether blocks are contextually related to the role of the user component 1128 as described above with reference to FIG. 7.

The computer-readable medium 1112 includes a using a second LLM to generate a response to the prompt and modified embeddings component 1130 as described above with reference to FIG. 8 and block 1018 of FIG. 10.

The computer-readable medium 1112 includes a knowledge base component 1132 as described above with reference to FIG. 2.

The computer-readable medium 1113 includes vector data store component 1134 as described above with reference to FIG. 2.

The computer-readable medium 1112 includes a definition of roles component 1136 as described above with reference to FIG. 6.

Note that FIG. 11 is just one example of a processing system consistent with aspects described herein, and other processing systems having additional, alternative, or fewer components are possible consistent with this disclosure.

### EXAMPLE CLAUSES

Implementation examples are described in the following numbered clauses:

Clause 1: A method, comprising: receiving a prompt input by a user via a user interface (UI) and a role of the user in the organization, the prompt containing a request for information from a knowledge base of an organization; inputting the prompt to a first large language model (LLM) to identify a block of text that is contained in a document stored in the knowledge base, semantically similar to the request for information, and accessible to the user based on the role of the user; inputting the block to a second LLM to generate a response to the request for information; and displaying the response in the UI, wherein the response contains the block of text that satisfies the request for information in the prompt and contains only the information the user is permitted to access based on the role of the user in the organization.

Clause 2: The method of Clause 1, wherein inputting the prompt to the first LLM to identify the block of text comprises: embedding each block of text contained in one or more documents stored in the knowledge base into a corresponding vector of a multi-dimensional space; embedding the prompt into a prompt vector in the multi-dimensional space; and calculating a measure of semantic similarity for each block of text and the text of the prompt to identify the block of text that is semantically similar to the request for information based on the corresponding vector of each block of text and the prompt vector.

Clause 3: The method of any of Clauses 1-2, wherein inputting the prompt to the first LLM to identify the block of text comprises: accessing definitions of roles in the organization; generating a set of safety prompts using a safety prompt template, each safety prompt having a different combination of a block of text that is semantically similar to text of the prompt and a definition a role in the organization; and separately inputting each safety prompt into the first LLM to generate a corresponding relevance score, wherein each relevance score is a measure of how closely related the text of the definition of the role is to the block of text of the safety prompt.

Clause 4: The method of any of Clauses 1-3 further comprising: comparing each relevance score to a relevance score threshold; identifying a block of text as belonging to a modified embedding based on the block of text and a definition of a role of the user having a relevance score greater than the relevance score threshold; and identifying a block of text as belonging to a safety embedding based on the block of text and a definition of a role that is not the role of the user having a relevance score greater than the relevance score threshold.

Clause 5: The method of any of Clauses 1-4, wherein inputting the block to second LLM to generate the response to the request for information comprises: forming a modified prompt from the prompt input by the user and blocks of text that are semantically similar to the text of the prompt and are contextually related to the definition of the role of the user; and inputting the modified prompt to the second LLM to generate the response.

Clause 6: The method of Clauses 1-5, wherein dividing the content of the documents stored in the knowledge base into the blocks of text comprises dividing the content into blocks of text with overlapping lines of text.

Clause 7: The method of Clause 1-6, further comprising dividing content of documents stored in the knowledge base into blocks of text with overlapping lines of text

Clause 8: One or more processing systems, comprising: one or more memories comprising computer-executable instructions; and one or more processors configured to execute the computer-executable instructions and cause the one or more processing systems to perform a method in accordance with any one of Clauses 1-7.

Clause 9: One or more processing systems, comprising means for performing a method in accordance with any one of Clauses 1-7.

Clause 10: One or more non-transitory computer-readable media comprising instructions that, when executed by one or more processors of a computing system, cause the computing system to perform the operations of any one of Clauses 1-7.

Clause 11: One or more computer program products embodied on one or more computer-readable storage media comprising code for performing a method in accordance with any one of Clauses 1-7.

### ADDITIONAL CONSIDERATIONS

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method, comprising:
receiving a prompt input by a user via a user interface (UI) and a role of the user in the organization, the prompt containing a request for information from a knowledge base of an organization;
inputting the prompt to a first large language model (LLM) to identify a block of text that is contained in a document stored in the knowledge base, semantically similar to the request for information, and accessible to the user based on the role of the user;
inputting the block to a second LLM to generate a response to the request for information; and
displaying the response in the UI, wherein the response contains the block of text that satisfies the request for information in the prompt and contains only the information the user is permitted to access based on the role of the user in the organization.

2. The method of claim 1, wherein inputting the prompt to the first LLM to identify the block of text comprises:
embedding each block of text contained in one or more documents stored in the knowledge base into a corresponding vector of a multi-dimensional space;
embedding the prompt into a prompt vector in the multi-dimensional space; and
calculating a measure of semantic similarity for each block of text and the text of the prompt to identify the block of text that is semantically similar to the request for information based on the corresponding vector of each block of text and the prompt vector.

3. The method of claim 1, wherein inputting the prompt to the first LLM to identify the block of text comprises:
accessing definitions of roles in the organization;
generating a set of safety prompts using a safety prompt template, each safety prompt having a different combination of a block of text that is semantically similar to text of the prompt and a definition a role in the organization; and
separately inputting each safety prompt into the first LLM to generate a corresponding relevance score, wherein each relevance score is a measure of how closely related the text of the definition of the role is to the block of text of the safety prompt.

4. The method of claim 3 further comprising:
comparing each relevance score to a relevance score threshold;
identifying a block of text as belonging to a modified embedding based on the block of text and a definition of a role of the user having a relevance score greater than the relevance score threshold; and
identifying a block of text as belonging to a safety embedding based on the block of text and a definition of a role that is not the role of the user having a relevance score greater than the relevance score threshold.

5. The method of claim 1, wherein inputting the block to the second LLM to generate the response to the request for information comprises:
forming a modified prompt from the prompt input by the user and blocks of text that are semantically similar to the text of the prompt and are contextually related to a definition of the role of the user; and
inputting the modified prompt to the second LLM to generate the response.

6. The method of claim 1, wherein the prompt is a mode of interaction that causes the second LLM to generate the response.

7. The method of claim 1, further comprising dividing content of documents stored in the knowledge base into blocks of text with overlapping lines of text.

8. A processing system, comprising:
one or more memories comprising computer-executable instructions; and
one or more processors configured to execute the computer-executable instructions and cause the processing system to:
receive a prompt input by a user via a user interface (UI) and a role of the user in the organization, the prompt containing a request for information from a knowledge base of an organization;
input the prompt to a first large language model (LLM) to identify a block of text that is contained in a document stored in the knowledge base, semantically similar to the request for information, and accessible to the user based on the role of the user;
input the block to a second LLM to generate a response to the request for information; and
display the response in the UI, wherein the response contains the one or more blocks of text that satisfies the request for information in the prompt and contains only the information the user is permitted to access based on the role of the user in the organization.

9. The processing system of claim 8, wherein to input the prompt to the first LLM to identify the block of text the one or more processors are configured to cause the processing system to:
embed each block of text contained in one or more documents stored in the knowledge base into a corresponding vector of a multi-dimensional space;
embed the prompt into a prompt vector in the multi-dimensional space; and
calculate a measure of semantic similarity for each block of text and the text of the prompt to identify the block of text that is semantically similar to the request for information based on the corresponding vector of each block of text and the prompt vector.

10. The processing system of claim 8, wherein to use the first LLM to identify the one or more blocks of text the one or more processors are configured to cause the processing system to:
access definitions of roles in the organization;
generate a set of safety prompts using a safety prompt template, each safety prompt having a different combination of a block of text that is semantically similar to text of the prompt and a definition a role in the organization; and
separately input each safety prompt into the first LLM to generate a corresponding relevance score, wherein each relevance score is a measure of how closely related the text of the definition of the role is to the block of text of the safety prompt.

11. The processing system of claim 10, the one or more processors are configured to cause the processing system to:
compare each relevance score to a relevance score threshold;
identify a block of text as belonging to a modified embedding based on the block of text and a definition of a role of the user having a relevance score greater than the relevance score threshold; and
identify a block of text as belonging to a safety embedding based on the block of text and a definition of a role that is not the role of the user having a relevance score greater than the relevance score threshold.

12. The processing system of claim 8, wherein to input the block to the second LLM to generate the response to the request for information the one or more processors are configured to cause the processing system to:
form a modified prompt from the prompt input by the user and blocks of text that are semantically similar to the text of the prompt and are contextually related to a definition of the role of the user; and
input the modified prompt to the second LLM to generate the response.

13. The processing system of claim 8, wherein the prompt is a mode of interaction that causes the first LLM to generate the response.

14. The processing system of claim 8, the one or more processors are further configured to divide content of documents stored in the knowledge base into blocks of text with overlapping lines of text.

15. A method, the method comprising:
displaying a user interface (UI) on a display device of a computer system that enables a user to input a prompt that contains a request for information in a knowledge base of an organization and input a role of the user in the organization;
in response to receiving the prompt as input,
accessing a data store of definitions of roles in an organization,
forming safety prompts from a safety prompt template, each safety prompt having a different combination of a block of text extracted from documents of the knowledge base and a definition of a role in the organization,
inputting each safety prompt into a first LLM to generate a corresponding relevance score, and
inputting the prompt and blocks of text with relevance scores that are greater than a relevance score threshold into a second LLM to generate a response to the prompt; and
displaying the response in the UI on the display device, the response containing the one or more blocks of text that satisfy the request for information in the prompt and the user is permitted to access based on the role of the user in the organization.

16. The method of claim 15, further comprising:
embedding each block of text into a vector of a multi-dimensional space;
embedding the prompt into a prompt vector in the multi-dimensional space;
calculating a cosine similarity between the prompt vector and each vector of the set of vectors; and
identifying one or more blocks of text that are semantically similar to text of the prompt, wherein the one or more blocks of text that are semantically similar to the text of the prompt have corresponding cosine similarities that are greater than a similarity threshold.

17. The method of claim 15, further comprising:
embedding each block of text into a vector of a multi-dimensional space;
embedding the prompt into a prompt vector in the multi-dimensional space; and
identifying one or more blocks of text that are semantically similar to text of the prompt using K-means clustering, wherein the one or more blocks of text that are semantically similar to the text of the prompt are closest to the prompt vector in the multidimensional space.

18. The method of claim 15, further comprising:
identifying a block of text as belonging to a modified embedding based on the block of text and a definition of a role of the user having a relevance score greater than the relevance score threshold; and
identifying a block of text as belonging to a safety embedding based on the block of text and a definition of a role that is not the role of the user having a relevance score greater than the relevance score threshold.

19. The method of claim 15, wherein the second LLM to generate the response comprises:
forming a modified prompt from the prompt and blocks of text that are semantically similar to the text of the prompt and are contextually related to a definition of the role of the user; and
inputting the modified prompt to the second LLM to generate the response.

20. The method of claim 15, wherein each relevance score is a measure of how closely related a definition of a role is to the block of text of the safety prompt.
